(19) United States
(12) Patent Application Publication
(10) Pub. No.: US 2026/0163080 A1
(43) Pub. Date: Jun. 11, 2026

(54) POUCH CONTAINMENT SYSTEM FOR THERMAL PROTECTION USING SENSOR INTEGRATION AND EMERGENCY RESPONSE TRIGGERS

(71) Applicant: ENEVATE CORPORATION, Irvine, CA (US)

(72) Inventor: Benjamin Yong Park, Irvine, CA (US)

(21) Appl. No.: 19/255,928

(22) Filed: Jun. 30, 2025

Related U.S. Application Data
(60) Provisional application No. 63/728,980, filed on Dec. 6, 2024.
(60) Provisional application No. 63/746,771, filed on Jan. 17, 2025.
(60) Provisional application No. 63/783,010, filed on Apr. 3, 2025.
(60) Provisional application No. 63/788,979, filed on Apr. 15, 2025.

(51) Int. Cl. H01M 10/42; H01M 10/48; H01M 10/63

(52) U.S. Cl. CPC H01M 10/425; H01M 10/486; H01M 10/63; H01M 2220/20

(57) ABSTRACT

This disclosure describes a battery device with at least two battery cells and a stainless-steel foil pouch located between the battery cells. The stainless-steel foil pouch holds a liquid and/or chemicals that prevent and/or delay thermal propagation. The battery device integrates sensors and emergency response triggers.

### CROSS REFERENCE TO RELATED APPLICATIONS

This application claims the benefit of and priority to U.S. Provisional Patent Application No. 63/728,980, titled “FOIL POUCH THERMAL BARRIER DEVICE FOR MITIGATING THERMAL PROPAGATION OF LITHIUM ION BATTERY,” filed Dec. 6, 2024. This application also claims the benefit of and priority to U.S. Provisional Patent Application No. 63/746,771, titled “FOIL POUCH THERMAL BARRIER DEVICE FOR MITIGATING THERMAL PROPAGATION OF LITHIUM ION BATTERY,” filed Jan. 17, 2025. This application also claims the benefit of and priority to U.S. Provisional Patent Application No. 63/783,010, titled “FOIL POUCH THERMAL BARRIER DEVICE FOR MITIGATING THERMAL PROPAGATION OF LITHIUM ION BATTERY,” filed Apr. 3, 2025. This application also claims the benefit of and priority to U.S. Provisional Patent Application No. 63/788,979, titled “FOIL POUCH THERMAL BARRIER DEVICE FOR MITIGATING THERMAL PROPAGATION OF LITHIUM ION BATTERY,” filed Apr. 15, 2025. Each of these disclosures are incorporated herein by reference in their entirety.

### BACKGROUND

Limitations and disadvantages of a traditional airbag assembly will become apparent to one of skill in the art, through comparison of approaches with some aspects of the present method and system set forth in the remainder of this disclosure with reference to the drawings.

### BRIEF SUMMARY

An airbag assembly with sensor integration and emergency response triggers for mitigating thermal propagation of lithium-ion battery, substantially as illustrated by and/or described in connection with at least one of the figures, as set forth more completely in the claims. The airbag may comprise a welded metal airbag. However, the materials (e.g., forming a pouch comprising a metallized polymer, stainless steel, or any other metal) and the sealing methods (e.g., welding, heat sealing, adhesive bonding, and others) may vary.

### BRIEF DESCRIPTION OF THE DRAWINGS

FIGS. 1-4 illustrate example batteries with anode variations, in accordance with various example implementations of this disclosure.

FIG. 5 illustrates an example thermal propagation test setup, in accordance with various example implementations of this disclosure.

FIG. 6 illustrates an example battery management system (BMS) for use in managing the operation of batteries, in accordance with various example implementations of this disclosure.

FIG. 7 is a flow diagram of an example lamination process for forming a silicon-dominant anode cell, in accordance with various example implementations of this disclosure.

FIG. 8 is a flow diagram of a direct coating process for forming a silicon-dominant anode cell, in accordance with an example embodiment of the disclosure.

FIG. 9 is a photograph of an example airbag with water inside (SSW pouch), in accordance with various example implementations of this disclosure.

FIGS. 10A and 10B are photographs of an example stainless steel box containing a stack of cells for TP testing, in accordance with various example implementations of this disclosure.

FIG. 11 illustrates an example thermal propagation test setup, in accordance with various implementations of this disclosure.

FIG. 12 illustrates example test results when Thermal propagation is delayed using insulative paint, in accordance with various example implementations of this disclosure.

FIG. 13 illustrates example test results when Thermal propagation is delayed using the SSW, in accordance with various example implementations of this disclosure.

FIG. 14 illustrates example test results of a benchmark control Si anode cell group, in accordance with various example implementations of this disclosure.

FIG. 15 illustrates example test results of a benchmark control graphite anode cell group, in accordance with various example implementations of this disclosure.

FIGS. 16A and 16B are photographs of an example TP test setup with cell clamping, where two cells were clamped, in accordance with various example implementations of this disclosure.

FIG. 17 illustrates examples of how the insulative paint layers and SS pouches may be arranged, in accordance with various example implementations of this disclosure. However, the paint and SS pouch layers may be arranged in any other possible combination not described here.

FIGS. 18-20 illustrates test results in which thermal propagation may be blocked by the SSW pouch under protection of the insulating paint, in accordance with various example implementations of this disclosure.

FIG. 21 illustrates a redundancy-enhancing approach using multiple parallel welds to minimize failure risks in accordance with various example implementations of this disclosure.

FIG. 22 presents data showing that boiled linseed oil coating significantly reduces water loss from defective SS pouches in a dry room environment in accordance with various example implementations of this disclosure.

FIG. 23 depicts weight loss over time for pouches containing sucrose-water solutions, demonstrating how solutes can slow vapor-phase water loss in case of leaks in accordance with various example implementations of this disclosure.

FIG. 24 illustrates a chamber assembly with sensor integration and emergency response triggers in accordance with various example implementations of this disclosure.

### DETAILED DESCRIPTION

The figures illustrate the general manner of construction, descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denotes the same elements.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

While the technology herein is often described as being incorporated into silicon batteries, the technology also applies to traditional non-silicon batteries and their manufacturing processes.

### Thermal Propagation

Lithium-ion battery (LIB) cells are commonly used in power tools, e-bikes, and electric vehicles. However, these batteries can sometimes malfunction, with thermal runaway (TR) being one possible failure mode. TR is a chain reaction that involves a rapid rise in cell temperature, cell rupture, decomposition and explosion due to gas release and uncontrolled fire. Such failures can result from mechanical impacts, foreign material penetration, or defects in electrical, thermal, or manufacturing processes. LIB cells have a limited tolerance for deviations from their specified temperature and voltage/current ranges. When these parameters are exceeded, it can cause overcharging and increase the risk of TR. Additionally, if a cell is damaged by debris during an accident, it might also enter a TR state.

TR in a single cell can quickly spread to adjacent cells, especially in large packs used in e-mobility or energy storage systems. This is referred to as thermal propagation (TP). For instance, TP within a vehicle's battery pack could jeopardize the entire vehicle and endanger the occupants. In cells with higher energy densities, such as those containing silicon or lithium metal, the safety concerns are more pronounced. These cells heat up more rapidly due to their lower heat capacity compared to traditional graphite or nickel-based cells. High-nickel cathodes like NMC622, NMC811, NCMA and NCA can exacerbate the issue by releasing oxygen, which accelerates TR.

TP can lead to significant property damage, injury, or even loss of life. This disclosure provides better safety, by reducing the risk of or preventing TP at the pack level and TR at the cell level.

In a typical pack without TP mitigation measures, when TR occurs in one cell, the heat generated is transferred to neighboring cells, eventually triggering thermal runaway in all cells. Generally, a thick thermal barrier (low thermal conductivity barrier like aerogel, ceramic, etc.) may block heat transfer from one cell to other cells to mitigate TP. A thick layer of thermal barrier will reduce the energy density of the system containing the cell. Accordingly, there is a need for a thinner thermal barrier that can also delay or avoid TP.

The heat conductivity of the thermal barrier material is important. A good thermal barrier should have low heat conductivity. Generally, heat-resistant ceramic paper has a thermal conductivity of ˜0.24 W/mK at 1000° C. While the Thermacel paint described below has a thermal conductivity of >0.1 W/mK. Water vapor, on the other hand, has a very low thermal conductivity (˜0.024 W/mK at 125° C.). For the same thickness, a water vapor layer between cells may efficiently block the heat transfer from cell to cell.

Ceramic paper and ceramic painting layers may also block heat transfer at normal operating temperatures. As a result, heat may accumulate during normal cell functioning. The accumulated heat may reduce cell cycle life and increase gassing.

This disclosure allows for thermal isolation when temperatures exceed a trigger temperature, which is higher than the operating temperature of the cell. However, unlike ceramic paper and ceramic painting layers, this disclosure also allows for heat transfer during normal operation.

### Example Batteries

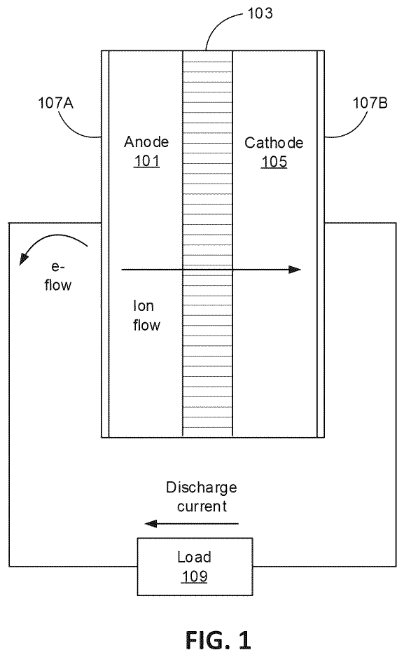

FIG. 1 illustrates an example battery with an anode variation. Referring to FIG. 1, there is shown a battery comprising a separator 103 sandwiched between an anode 101 and a cathode 105, with current collectors 107A and 107B. There is also shown a load 109 coupled to the battery illustrating instances when the battery is in discharge mode. In this disclosure, the term “battery” may be used to indicate a single electrochemical cell, a plurality of electrochemical cells formed into a module, and/or a plurality of modules formed into a pack. Furthermore, the battery shown in FIG. 1 is a very simplified example merely to show the principle of operation of a lithium-ion cell.

The development of portable electronic devices and electrification of transportation drive the need for high-performance electrochemical energy storage. In devices ranging from small-scale (<100 Wh) to large-scale (>10 kWh), LIBs are widely used over other rechargeable battery chemistries due to their advantages in energy density and cyclability.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode 105 are electrically coupled to the current collectors 107A and 107B, which comprise metal or other conductive material for providing electrical contact to the electrodes as well as physical support for the active material in forming electrodes.

The configuration shown in FIG. 1 illustrates the battery in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, separator 103, cathode 105, and anode 101 materials are individually formed into sheets, films, or active material coated foils. In this regard, different methods or processes may be used in forming electrodes, particularly silicon-dominant (>50% in terms of active material by capacity or by weight) anodes. For example, lamination or direct coating may be used in forming a silicon-containing anode (silicon anode). Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄, LIFSI, LiTFSI, etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more cyclic carbonates, such as ethylene carbonate (EC), fluoroethylene carbonate (FEC), or propylene carbonate (PC) as well as linear carbonates, such as ethyl methyl carbonate (EMC), diethyl carbonate (DEC), and dimethyl carbonate (DMC), in various percentages. In some embodiments, the electrolyte solvents may comprise one or more of EC from about 0-40%, FEC from about 2-40% and/or EMC from about 50-70% by weight.

The separator 103 may be soaked with a liquid or gel electrolyte. In addition, in an example embodiment, the separator 103 does not melt below about 100 to 140° C., and exhibits sufficient mechanical properties for battery applications. A battery, in operation, can experience expansion and contraction of the anode 101 and/or the cathode 105. In an example embodiment, separator 103 can expand and contract by at least 5 to 10% without tearing or otherwise failing and may also be flexible. Separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery, providing electrical connections to the device for transfer of electrical charge in charge and discharge states. The anode 101 may comprise silicon, carbon, or combinations of these materials, for example. Typical anode electrodes comprise a carbon material and a current collector, such as a copper sheet. Carbon is often used because it has excellent electrochemical properties and is also electrically conductive. Anode electrodes currently used in rechargeable lithium-ion cells typically have a specific capacity of approximately 200 milliamp hours per gram (mAh/g). Graphite, the active material used in most lithium-ion battery anodes, has a theoretical energy density of 372 mAh/g. In comparison, silicon has a high theoretical capacity of 4200 mAh/g. To increase volumetric and gravimetric energy density of lithium-ion batteries, silicon may be used as the active material for the cathode 105 or anode 101. Si anodes may be in the form of a composite on a current collector, with >50% Si by capacity or weight in the composite layer.

In an example scenario, the anode 101 and cathode 105 store the ions used for separation of charge, such as lithium ions. In this example, the electrolyte carries positively charged lithium ions from the anode 101 to the cathode 105 in discharge mode, as shown in FIG. 1, and vice versa through the separator 103 in charge mode. The movement of the lithium ions and reactions with the electrodes create free electrons in one electrode which creates a charge at the opposite current collector. The electrical current then flows from the current collector where charge is created through load 109 to the other current collector. The separator 103 blocks the flow of electrons inside the battery 100, allows the flow of lithium ions, and prevents direct contact between the electrodes.

While the battery is discharging and providing an electric current, the anode 101 releases lithium ions to the cathode 105 through the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current LIBs need to be improved to, for example, compete with internal combustion engine (ICE) technology and allow for the widespread adoption of electric vehicles (EVs). High energy density and high-power density of LIBs are achieved with the development of high-capacity and high-voltage cathodes, high-capacity anodes and electrolytes with high voltage stability and interfacial compatibility with electrodes. In addition, materials with low toxicity are beneficial as battery materials to reduce process costs and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be improved by incorporating conductive additives with different morphological properties. Carbon black (Super P), vapor grown carbon fibers (VGCF), and a mixture of the two have previously been incorporated into the anode to improve electrical conductivity and otherwise improve performance. The synergistic interactions between the two carbon materials may facilitate electrical contact throughout the large volume changes of the silicon anode during charge and discharge as well as provide additional mechanical robustness to the electrode and provide mechanical strength (e.g., to keep the electrode material in place). These contact points (especially when utilizing high-aspect-ratio conductive materials) facilitate the electrical contact between anode material and current collector to mitigate the isolation (island formation) of the electrode material while also improving conductivity in between silicon regions. Graphene and carbon nanotubes may be used because they may show similar benefits. Thus, in some instances, a mixture of two or more of carbon black, vapor grown carbon fibers, graphene, and carbon nanotubes may be used independently or in combinations for the benefits of conductivity and other performance.

LIBs may employ a graphite-dominant anode which is a lithium intercalation type anode. Silicon-dominant anodes, however, may offer improvements compared to graphite-dominant Li-ion batteries. Silicon exhibits both higher gravimetric (4200 mAh/g vs. 372 mAh/g for graphite) and volumetric capacities (2194 mAh/cc vs. 890 mAh/cc for graphite). In addition, Si has a higher redox reaction potential versus Li compared to graphite, with a voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separating the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles together in the anode, (b) is flexible enough to accommodate the large volume expansion and contraction of silicon, and (c) allows a fast conduction of electrons within the matrix.

Therefore, there is a trade-off among the functions of active materials, conductive additives and polymer binders. The balance may be adversely impacted by high energy density silicon anodes with low conductivity and huge volume variations described above. Polymer binder(s) may be pyrolyzed to create a pyrolytic carbon matrix with embedded silicon particles. In addition, the polymers may be selected from polymers that are completely or partially soluble in water or other environmentally benign solvents or mixtures and combinations thereof. Polymer suspensions of materials that are non-soluble in water could also be utilized.

In some embodiments, dedicated systems and/or software may be used to control and manage batteries or packs thereof. In this regard, such dedicated systems may comprise suitable circuitry for running and/or executing control and managing related functions or operations. Further, such software may run on suitable circuitry, such as on processing circuitry (e.g., general processing units) already present in the systems or it may be implemented on dedicated hardware. For example, battery packs (e.g., those used in electric vehicles) may be equipped with a battery management system (BMS) for managing the batteries (or packs) and operations.

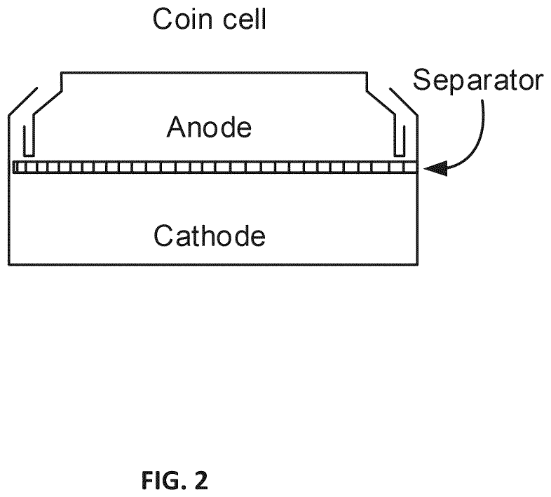

FIG. 2 illustrates an example SOCD coupled to a coin cell.

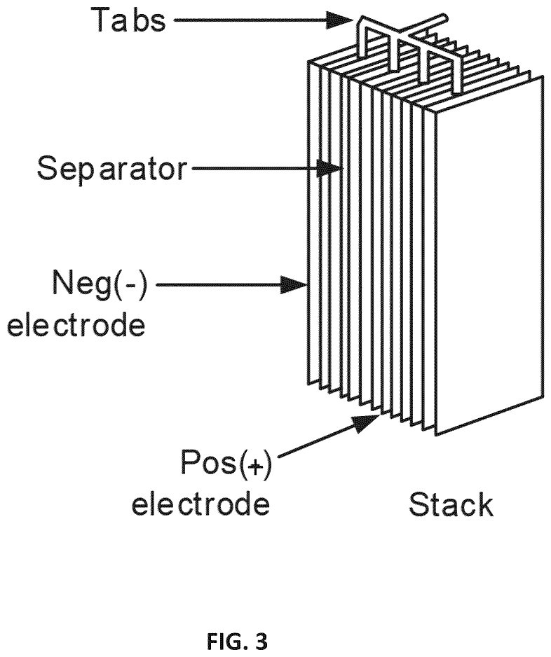

FIG. 3 illustrates an example SOCD coupled to a stack of electrodes.

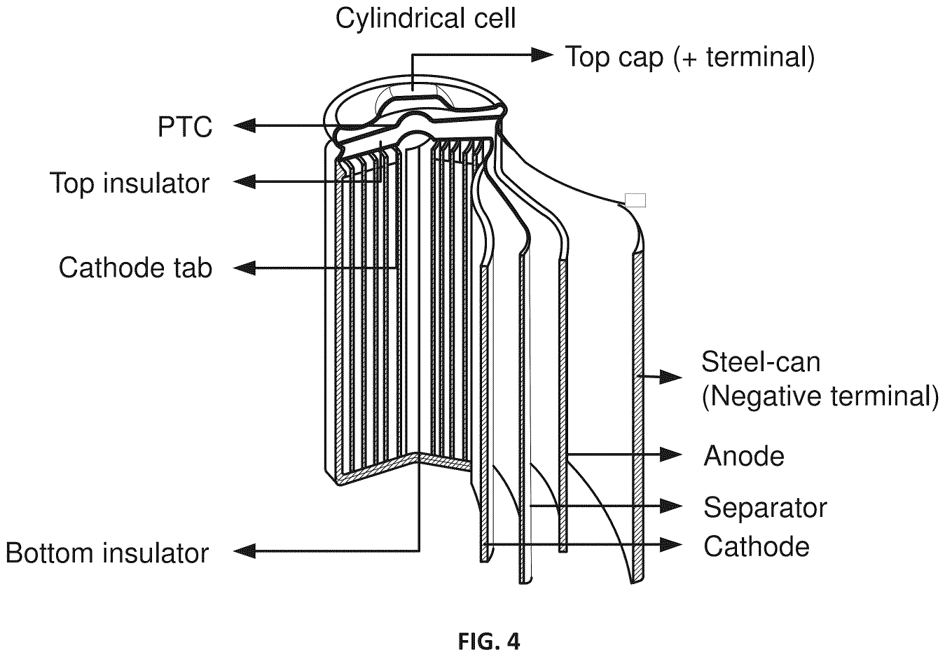

FIG. 4 illustrates an example SOCD coupled to a cylindrical metal can cell.

### TP Testing

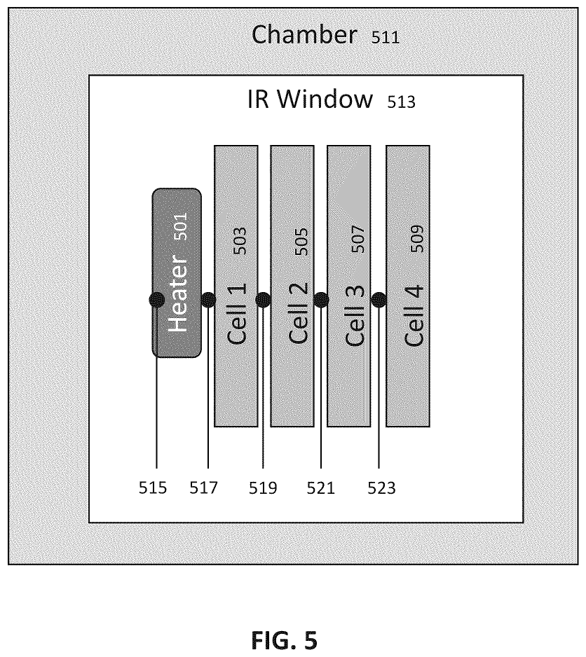

FIG. 5 illustrates an example TP test setup, in accordance with various implementations of this disclosure.

The TP test setup, shown in FIG. 5, includes a heater 501 and four pouch cells 503, 505, 507 and 509 within a heat-resistant ceramic chamber 511 equipped with an IR window 513.

During the TP test, a heater 501 (e.g., 200W heater) heats cell 1 503, while thermocouples 515, 517, 519, 521 and 523 measure the temperature of the heater 501 and the temperature changes between the cells 503, 505, 507 and 509. An IR sensor, installed through the IR window 513, provides accurate temperature and ignition timing measurements. The test is conducted in a controlled environment with a ceramic chamber 511 of approximately 1 cubic foot, featuring a tempered glass viewing window 513. Typically, four cells 503, 505, 507 and 509 are stacked with the top of one cell touching the bottom of the next. Only the bottom of the first cell 503 is directly on the heater 501. No external barriers are placed between the cells. The heater 501 covers 20% of the cells' area, with heating controlled to achieve a ramping rate of over 15° C./sec. A thermocouple 517 between the heater and the first cell 503 measures the heater's ramping rate to ensure it meets the design specifications. Key test outputs include the time required for TP and the maximum temperature reached by the cells. Additionally, depending on the criteria of testing, the setup gives options for testing cells to be clamped under a pressure range of 10-500 kPa, more ideally, 50 kPa to 400 kPa. Pressure may be introduced using a constant-gap setup with foam pads positioned atop the cell stack. This setup may be applied during TP testing, yielding consistent results also mimicking the environment of a module or battery pack. The cells may be connected in series and/or parallel configurations or left unconnected.

### Battery Management and Manufacturing

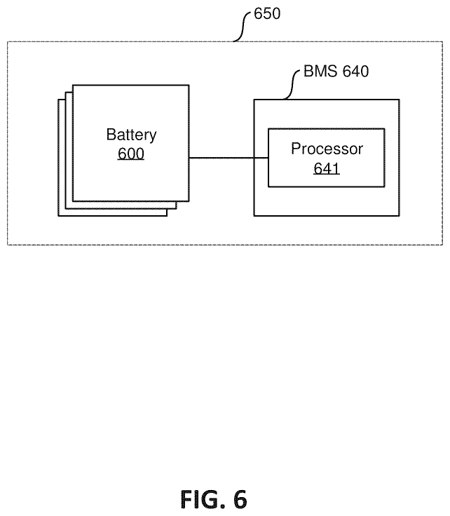

FIG. 6 illustrates an example battery management system (BMS) for use in managing operation of batteries. Shown in FIG. 6 is battery management system (BMS) 140.

The battery management system (BMS) 640 may comprise suitable circuitry (e.g., processor 641) configured to manage one or more batteries (e.g., each being an instance of the battery 600 as described with respect with FIGS. 1-4). In this regard, the BMS 640 may be in communication and/or coupled with each battery 600. In some implementations, a separate processor (e.g., a conventional processor, such as an electronic control unit (ECU), a microcontroller unit (ECU), or the like), or several such separate processors, may be used, and may be configured to handle algorithms or control functions with regards to the batteries. In such implementations, such processor(s) may be connected to the batteries, such as through processor 641, and thus may be treated as part of the BMS 640 and acting as part of processor 641.

In some embodiments, the battery 600 and the BMS 640 may be in communication and/or coupled with each other, for example, via electronics or wireless communication. In some embodiments, BMS 640 may be incorporated into the battery 100. Alternatively, in some embodiments, BMS 640 and the battery 600 may be combined into a common package 650. Further, in some embodiments, the BMS 640 and the battery 100 may be separate devices/components and may only be in communication with one another when present in the same system. The disclosure is not limited to any particular arrangement, however.

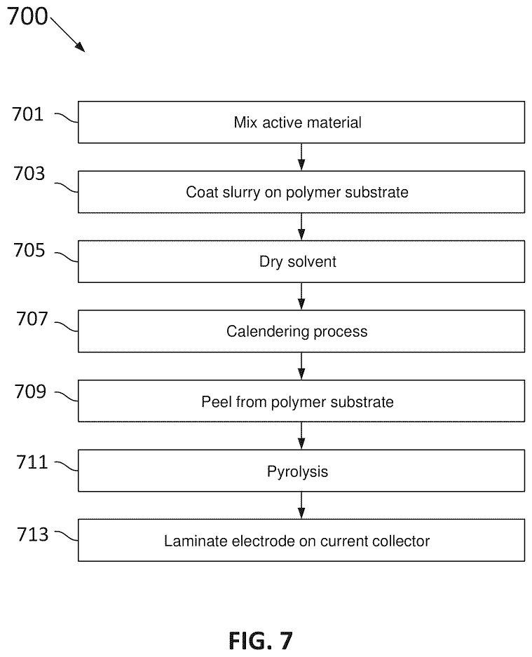

FIG. 7 is a flow diagram of an example lamination process 700 for forming a silicon-dominant anode cell. This process employs a high-temperature pyrolysis process on a substrate, layer removal, and a lamination process to adhere the active material layer to a current collector. This strategy may also be adopted by other types of anodes, such as graphite, conversion type anodes, such as transition metal oxides, transition metal phosphides, and other alloy type anodes, such as Sn, Sb, Al, P, etc.

To fabricate an anode, the raw electrode active material is mixed in step 701. In the mixing process, the active material may be mixed with a binder/resin (such as water soluble PI (polyimide), PAI (polyamideimide), carboxymethyl cellulose (CMC), styrene-butadiene rubber (SBR), poly(acrylic acid) (PAA), Sodium Alginate, Phenolic or other water soluble resins and mixtures and combinations thereof), solvent, rheology modifiers, surfactants, pH modifiers, and conductive additives. The materials may comprise carbon nanotubes/fibers, graphene sheets, metal polymers, metals, semiconductors, and/or metal oxides, for example. Silicon powder with a 1-30 or 5-30 μm particle size, for example, may then be dispersed in polyamic acid resin, PAI, or PI (15-25% solids in N-Methyl pyrrolidone (NMP) or deionized (DI) water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of water-soluble polyelectrolytes, such as polyamic acid, carboxymethyl cellulose, or polyacrylic acid. Ionic or non-ionic surfactants may be added to facilitate the wetting of the insoluble components of the slurry or the substrates used for coating processes. The particle size and mixing times may be varied to configure the electrode coating layer density and/or roughness.

Furthermore, cathode electrode coating layers may be mixed in step 701, and coated (e.g., onto aluminum), where the electrode coating layer may comprise cathode material mixed with carbon precursor and additive as described above for the anode electrode coating layer. The cathode material may comprise Lithium Nickel Cobalt Manganese Oxide (NMC (also called NCM): LiNiₓCo_{y}Mn_{z}O₂, x+y+z=1), Lithium Iron Phosphate (LFP: LiFePO₄/C), Lithium Nickel Manganese Spinel (LNMO: e.g. LiNi_{0.5}Mn_{1.5}O₄), Lithium Nickel Cobalt Aluminum Oxide (NCA: LiNiₐCo_{b}Al_{c}O₂, a+b+C=1), Lithium Manganese Oxide (LMO: e.g. LiMn₂O₄), a quaternary system of Lithium Nickel Cobalt Manganese Aluminum Oxide (NCMA: e.g. Li[Ni_{0.89}Co_{0.05}Mn_{0.05}Al_{0.01}]O₂, Lithium Cobalt Oxide (LCO: e.g. LiCoO₂), and other Li-rich layer cathodes or similar materials, or combinations thereof. The particle size and mixing times may be varied to configure the electrode coating layer density and/or roughness.

In step 703, the slurry may be coated on a substrate. In this step, the slurry may be coated onto polyester, polyethylene terephthalate (PET), or Mylar film at a loading of, e.g., 2-4 mg/cm² and then undergo drying in step 705 to an anode coupon with high Si content and less than 15% residual solvent content. This may be followed by an optional calendering process in step 707, where a series of hard pressure rollers may be used to finish the film/substrate into a smooth and denser sheet of material.

In step 709, the active-material-containing film may then be removed from the PET, where the active material layer may be peeled off the polymer substrate. The peeling may be followed by a pyrolysis step 711 where the material may be heated to, e.g., 600-1250° C. for 1-3 hours, cut into sheets, and vacuum dried using a two-stage process (120° C. for 15 h, 220° C. for 5 h). The peeling process may be skipped if polypropylene (PP) substrate is used, and PP can leave ˜2% char residue upon pyrolysis.

In step 713, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

The cell may be assessed before being subject to a formation process. The measurements may comprise impedance values, open circuit voltage, and electrode and cell thickness measurements. The formation cycles are defined as any type of charge/discharge of the cell that is performed to prepare the cell for general cycling and is considered part of the cell production process. Different rates of charge and discharge may be utilized in formation steps. During formation, the initial lithiation of the anode may be performed, followed by delithiation. Cells may be clamped during formation and/or cycling.

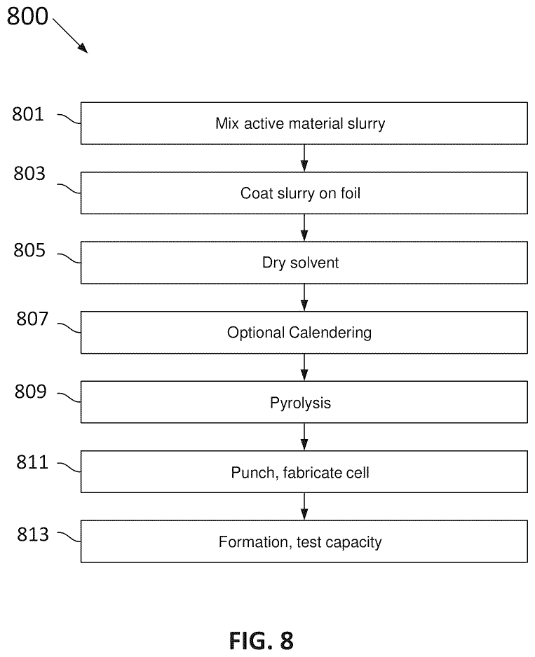

FIG. 8 is a flow diagram of a direct coating process 800 for forming a silicon-dominant anode cell, in accordance with an example embodiment of the disclosure. This process comprises physically mixing the active material, conductive additive, and binder together, and coating the mixed slurry directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 801, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 μm particle size, for example, may then be dispersed in polyamic acid resin, PAI, PI (15% solids in DI water or N-Methyl pyrrolidone (NMP)) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 801, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 803, the slurry may be coated on a copper foil. In the direct coating process described here, an anode slurry is coated on a current collector with residual solvent followed by a drying and a calendering process for densification. A pyrolysis step (˜500-800° C.) is then applied such that carbon precursors are partially or completely converted into glassy carbon or pyrolytic carbon. Similarly, cathode active materials may be coated on foil material, such as aluminum, for example. The active material layer may undergo a drying process in step 805 to reduce residual solvent content. An optional calendering process may be utilized in step 807 where a series of hard pressure rollers may be used to finish the film/substrate into a smoother and denser sheet of material. In step 807, the foil and coating optionally proceed through a roll press for calendering where the surface is smoothed out and the thickness is controlled to be thinner and/or more uniform.

In step 809, the active material may be pyrolyzed by heating to 500-1000° C. such that carbon precursors are partially or completely converted into glassy carbon. Pyrolysis can be done either in roll form or after punching. If the electrode is pyrolyzed in a roll form, it will be punched into individual sheets after pyrolysis. The pyrolysis step may result in an anode active material having silicon content greater than or equal to 50% by capacity or by weight. In an example scenario, the anode active material layer may comprise 20 to 95% silicon. In another example scenario may comprise 50 to 95% silicon by weight. In instances where the current collector foil is not pre-punched/pre-perforated, the formed electrode may be perforated 811 with a punching roller, for example. The punched anodes may then be used to assemble a cell with cathode, separator and electrolyte materials. In some instances, separators with significant adhesive properties may be utilized.

In step 813, the cell may be assessed before being subject to a formation process. Measurements may comprise impedance values, open circuit voltage, and cell and/or electrode thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in formation steps.

### SSW Pouch

This disclosure focuses on an airbag assembly with sensor integration and emergency response triggers for mitigating thermal propagation of lithium-ion battery, substantially as illustrated by and/or described in connection with at least one of the figures, as set forth more completely in the claims. The airbag may comprise a stainless steel pouch with water (SSW). However, the materials (e.g., forming a pouch comprising a metallized polymer, stainless steel, or any other metal), the sealing methods (e.g., welding, heat sealing, adhesive bonding, and others), and filler (e.g., water and/or other additives) may vary.

A stainless steel foil pouch with a small amount of liquid and/or foam (e.g., water, fire retardant/intumescent material, etc.) inside (e.g., SSW pouch) may be used to prevent TP. Batteries may comprise one or more cells with one or more SSW's placed between cells to improve safety.

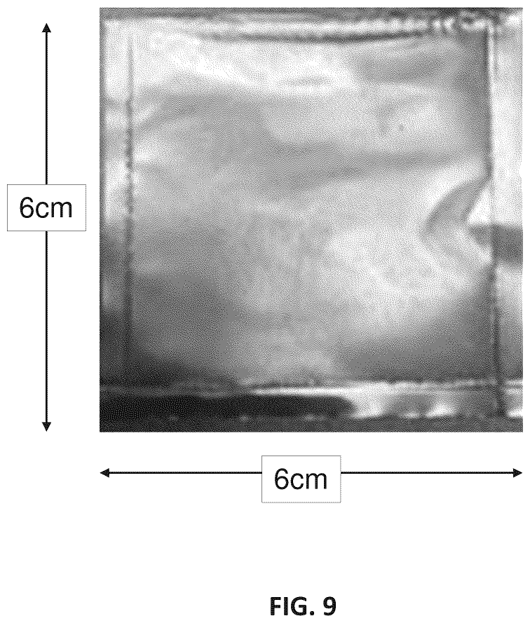

FIG. 9 is a photograph of an example SSW pouch, in accordance with various example implementations of this disclosure.

The example SSW pouch is 6 cm×6 cm in size and filled with 10 μL water inside. The SSW pouch may be made with 309 Stainless steel which has a melting point ranging between 1400-1455° C. Because a small amount of water will generate a large volume of water vapor at 100° C., a very small amount of water is required in the pouch. For example, 1 g (1 ml) water can convert to 1650 ml water vapor at 100° C. Approximately 0.01 g water is needed to form a 2 mm thick water vapor gap under 110 kPa (6.1 cm³).

When the temperature of the SSW pouch is greater than 100° C., the device puffs up and resembles a pillow due to the expanding water vapor inside. The puffed-up device functions as an effective thermal barrier between cells. The pouch is hermetically sealed so that it will not leak when liquid water converts to water vapor. The metal foil is required to resist the high temperatures during a thermal runaway event. Therefore, the metal foil material may comprise stainless steel, titanium, copper Inconel (e.g., Inconel 600, 625, 718, 740H, 22, X), chromium, chrome-plated metals, gold-plated metals, silver-plated metals, molybdenum, nickel, plated carbon steel, steel, tungsten and/or other metals depending on design priorities like weight, strength, or thermal conductivity. The metal foil thickness depends on needs. The thickness may vary from 10 μm to 500 μm. The water amount depends on the pouch size, the pressure applied on the pouch, and the gap distance designed. Generally, 1 ml water will generate 1650 ml water vapor at a temperature >100° C.

The SSW pouch may be welded shut using an AC welder or it may be sealed with a sealant. The SSW pouch may also be welded using ultrasonic or other methods. The fluid inside may be chosen to trigger at different temperatures depending on the volatility of the fluid as well as the boiling point. Insulating material or paint may be added to the surface of the stainless steel pouch or inside of the pouch to add more insulation or to prevent melting of the metal.

The SSW pouch may be placed on one side of a prismatic can or pouch cell or on both sides. It can also be wrapped around these types of cells or around a cylindrical cell.

The pouch may comprise suspended solids such as aluminum oxide, silica, magnesium hydroxide, aluminum hydroxide, lithium hydroxide, graphite, expanded graphite, expandable graphite, soft/hard carbon or magnesium oxide may provide both thermal inertia and heat buffering.

There are several advantages of this metal foil pouch thermal barrier device compared to other thermal barriers. First, the device has a very low heat conductivity at high temperature because of the low heat conductivity of water vapor inside. The heat conductivity of water vapor (˜0.024 W/mK at 125° C.) is significantly lower than other thermal barriers such as ceramic paper. Therefore, the SSW pouch may significantly reduce the heat transfer when one cell has thermal runaway even with a thinner thickness of the device. The SSW pouch may delay the TP time significantly. For example, as described in Table 2, when two 100 μm thick pouches filled with 10 μL water each (total thickness of about 210 μm) were used as thermal barriers between the cells, the TP time may be delayed to 302 s in an enclosed TP setup compared to 190 s for a 325-microns thick insulating paint barrier.

Second, the SSW pouch may minimize the reduction of cell or battery pack energy density when used to mitigate the TP. Under 100° C., the small amount of water inside of the pouch is liquid and occupies a small amount of space. It will expand to a designed volume at a high temperature (>100° C.). Therefore, the SSW pouch is thin and will not take too much space for the cell or battery pack at its functioning temperature (usually <60° C.). Furthermore, the thickness of the metal foil is adjustable based on the target applications. It could be 10 μm or more, if it is strong enough to hold the water vapor at high temperatures.

Many thermal barriers are 1 mm or thicker to mitigate TP. The SSW pouch is an active device as it utilizes a phase change. Furthermore, the SSW pouch is thinner than many passive barriers.

Third, the SSW pouch may help with cell heat dissipation in its normal functioning temperature range and only block the heat transfer when the cell temperature exceeds 100° C., at which time the cell is at high risk of entering thermal runaway. To maximize the lifespan of the cell, the cell needs to remain within an appropriate temperature range, for example between 25° C. to 45° C. Cells typically generate heat during charging or discharge which needs to be dissipated efficiently to reduce cell degradation. Other thermal barriers, such as ceramic paper, block the heat transfer under all temperatures including under cell functioning temperatures, which may degrade the cell performance. Therefore, the SSW pouch is better than other thermal barriers within the normal operating temperature range.

The thermal barrier will expand to a much thicker thickness and compress other materials in the pack or module such as interface materials or foams. Otherwise, the bearer, when expanded, may compress the other cells or expand the frame to create space. Finally, the barrier may occupy the space freed up when a cell goes into thermal runaway and loses significant volume and/or mass due to reactions/outgassing/or other expulsion of materials.

In addition, compared to other thermal barriers used in the industry such as aerogels, the SSW pouch may be much less expensive.

### TP Testing

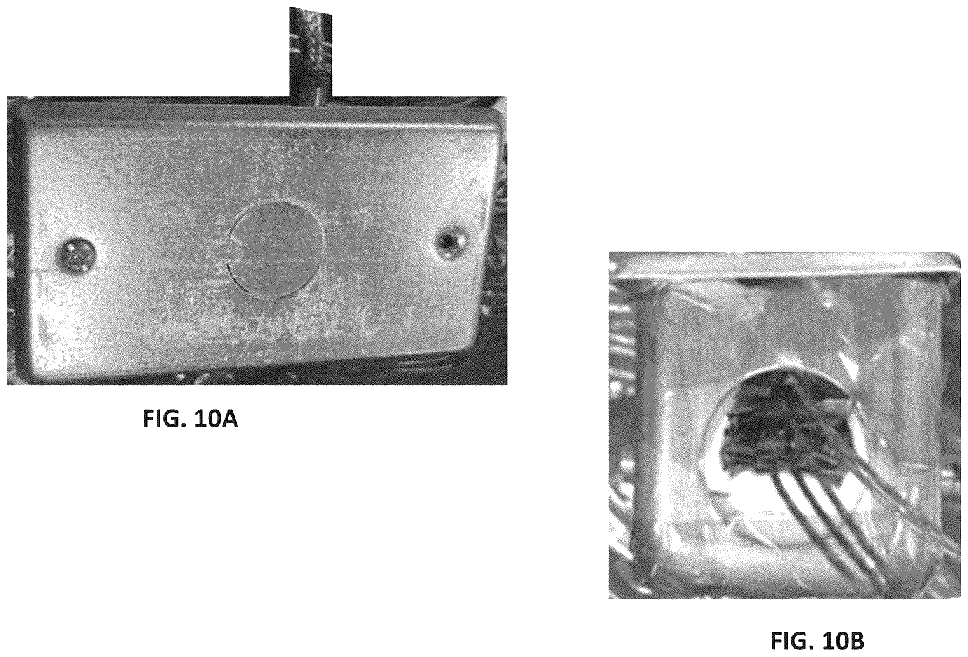

FIGS. 10A and 10B are photographs of an example stainless steel box containing a stack of cells for TP testing, in accordance with various example implementations of this disclosure.

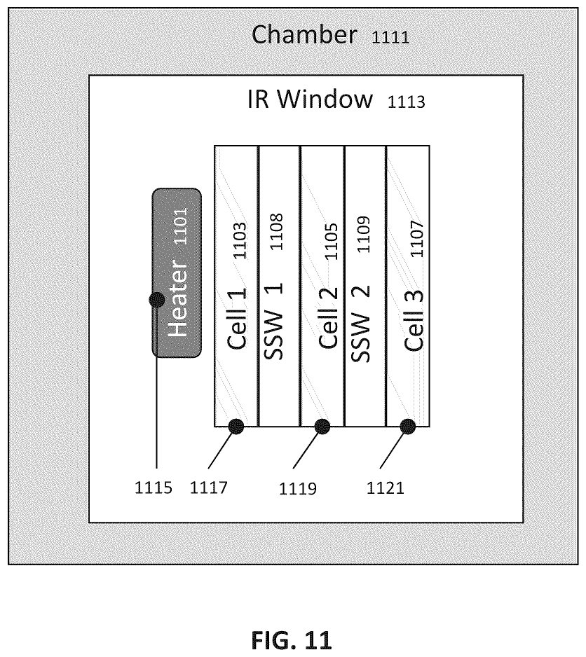

FIG. 11 illustrates an example of TP test setup, in accordance with various implementations of this disclosure.

The TP test setup, shown in FIG. 11, includes a heater 1101 and three cells 1103, 1105, 1107 within a heat-resistant ceramic chamber 1111 equipped with an IR window 1113.

During the TP test, a heater 1101 (e.g., 200W heater) heats cell 1 1103, while thermocouples 1115, 1117, 1119, 1121 measure the temperature of the heater 1101 and the temperature changes between the cells 1103, 1105, 1107 with SSW's 1108, 1109 in-between cells. An IR sensor, installed through the IR window 1113, provides accurate temperature and ignition timing measurements. The test is conducted in a controlled environment with a ceramic chamber 1111 of approximately 1 cubic foot, featuring a tempered glass viewing window 1113. The three cells 1103, 1105, 1107 are stacked with the top of cell 1 1103 touching SSW pouch 1 1108, which touches the bottom of cell 2 1105, etc. Only the bottom of the first cell 1103 is directly on the heater 1101. The heater 1101 covers 20% of the cells' area, with heating controlled to achieve a ramping rate of over 15° C./sec. A thermocouple 1117 between the heater and the first cell 1103 measures the heater's ramping rate to ensure it meets the design specifications. Key test outputs include the time required for TP and the maximum temperature reached by the cells.

TABLE 1
TP test result comparison

| | | | Barrier |
|---|---|---|---|
| | Tp Time | | Thickness |
| Type | C1-C4 | Max temp | (μm) |
| Standard gen 5-Si anode cell | 18 s | 1376 | 0 |
| Graphite cells | 48 s | 962 | 0 |
| Si cell with Insulating Paint | 190 s | 1350 | 325 |

The typical propagation time for the control cell (a silicon cell without the insulating layer built in) is ˜18 seconds in which the temperature normally exceeds 1300° C. Propagation time is defined as the time between the first cell entering thermal runaway and the last cell entering thermal runaway.

Table 2, below, shows TP results comparing insulating paint (i.e., ThermaCels and Flame Seal products) with the SSW device.

| Barrier Type | TP Time C1-C4 | Thickness (um) |
|---|---|---|
| Insulating Paint | 190 s | 325 |
| Stainless steel pouch | 302 s | 210 |

Prior to the thermal propagation (TP) test, the cells are charged to 4.2 V at 0.33 C with a current taper of 0.05 C at the end. Each cell has a rated capacity of 2 Ah.

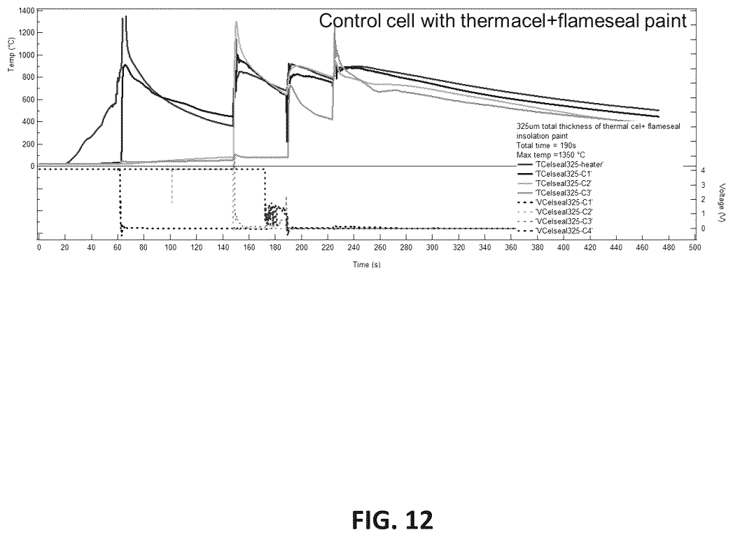

FIGS. 12-15 illustrate the results of experiments in which TP may (or may not) be blocked.

FIG. 12 shows results for a 2 Ah control cell TP test with ThermaCels+Flame Seal paint.

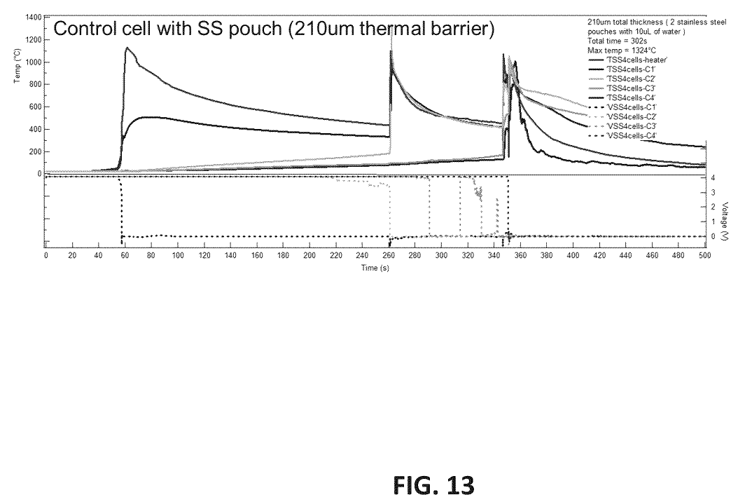

FIG. 13 shows results for a 2 Ah control cell (NCM811-Si) TP test with stainless steel pouch thermal barrier device between cells. Two devices were added between cells, and the total thickness is about 210 μm (for two layers-one on each side of the cell).

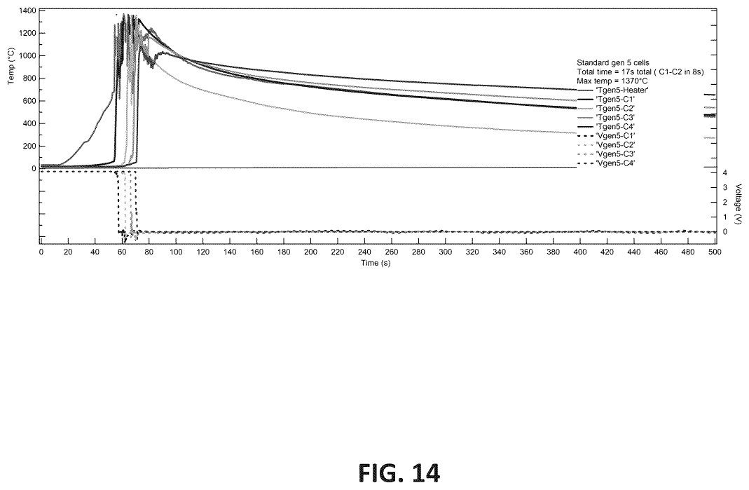

FIG. 14 shows results for a 2 Ah control cell (NCM811-Si) TP test.

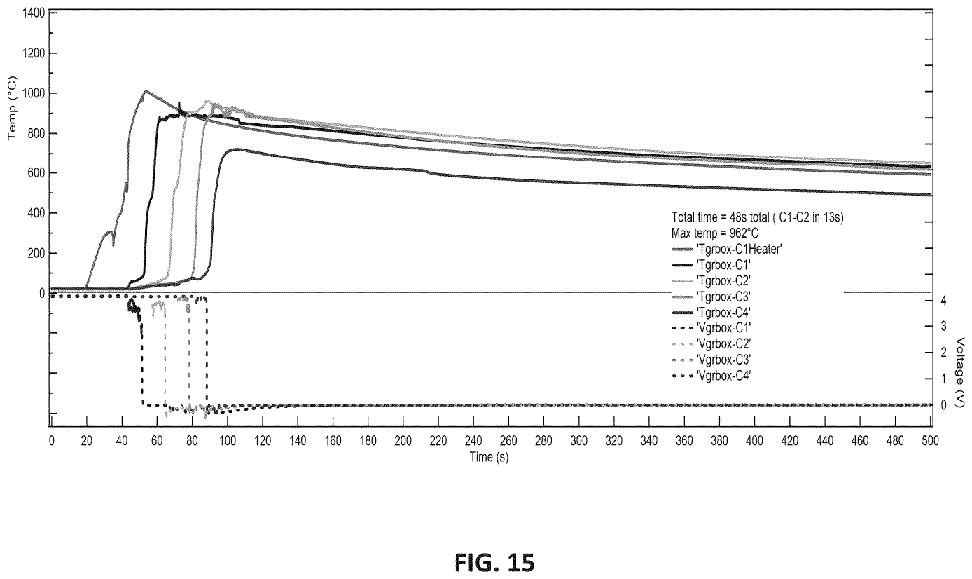

FIG. 15 shows results for a 2 Ah graphite cell TP test.

This disclosure demonstrates significant improvements in delaying or stopping TP within battery packs. Experimental results show that the use of the SSW pouch technique can delay or stop thermal propagation.

SSW in Combination with Additional Safety-Enhancement

Additional safety features may be included within a cell. All features may be enclosed within a cell enclosure. The SSW pouch may be combined with other technologies. Within a battery pack, different cells may incorporate varying technologies, such as alternating high heat capacity cells. The overall safety design may also depend on pack components like heat plates or foams, which might negate the need for internal insulating layers or higher heat capacity designs.

### Use of ThermaCels-Flame Seal Paint

The insulative paint used here is a combination of ThermaCels (https://hytechsales.com/insulating-additive-ThermaCels), a ceramic insulative additive with low thermal conductivity (0.1 W/m/K) and the ability to withstand high temperatures (˜1800° C.). The second component is an intumescent paint (Flame Seal FX-100−https://www.FlameSealshop.com/category/fx-100/), which serves as a non-flammable binder as well as an intumescent barrier when activated at high temperatures. The insulative paint may include any ratio of ThermaCels to Flame Seal material and needs to be optimized for processability and effectiveness. Another option to optimize the thermal insulation layer effect is to add the base coat (Flame Seal ADH1) on a substrate. As an example, the substrate may already have an adhesive (e.g., silicone tape). This can help increase the adhesion of the intumescent paint (or other insulating layer) to the cell (many cells have a plastic material as an outside layer). A protective topcoat (e.g., acrylic latex) may be added to protect the underlying coating.

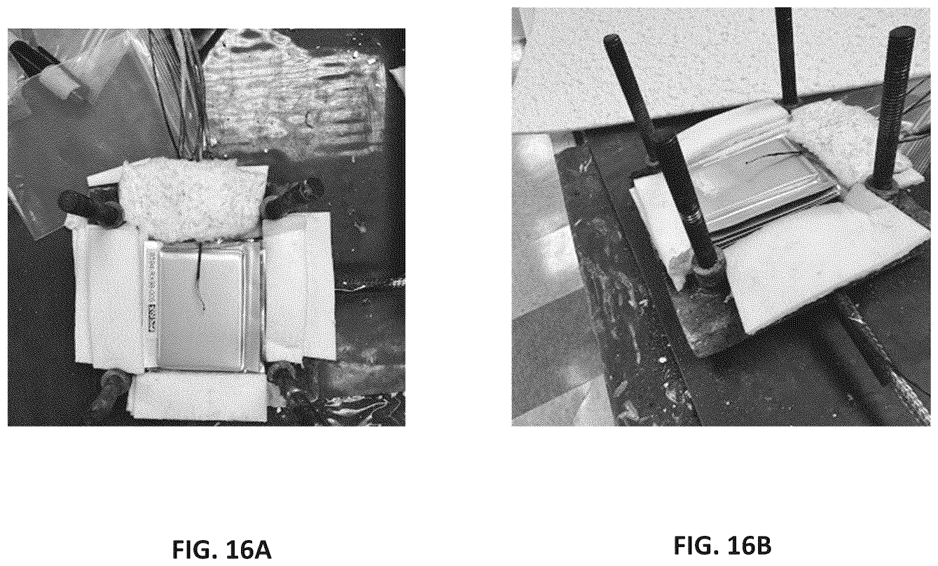

FIGS. 16A and 16B are photographs of an example TP test setup with cell clamping, where two cells were clamped, in accordance with various example implementations of this disclosure.

Different barrier designs may be tested using TP setup, where two cells are clamped but not enclosed in an insulative box. This setup, depicted in FIGS. 16A and 16B, ensures that the cells are clamped under a pressure of 50-150 kPa to replicate the clamping conditions the cells may experience in an actual pack. Another difference between this clamped TP setup and the previously described setup (in FIGS. 10A and 10B) is that the cells are not enclosed within an insulative box. Therefore, it should be noted that the TP results from this setup cannot be directly compared to the results obtained from the previously described enclosed setup.

Thermal barriers containing a combination of the insulative paint and stainless steel (SS) pouches may be implemented in a variety of ways. For example, the insulative paint may be directly coated onto the SS pouch or the outer surface of the cells. Alternatively, the insulative paint may be applied to a thin substrate such as plastic/polymer sheets (e.g., PET, Teflon, polyimide), metal foils (e.g., copper, stainless steel, titanium), ceramic paper, etc., and inserted into the thermal barrier as a self-standing sheet.

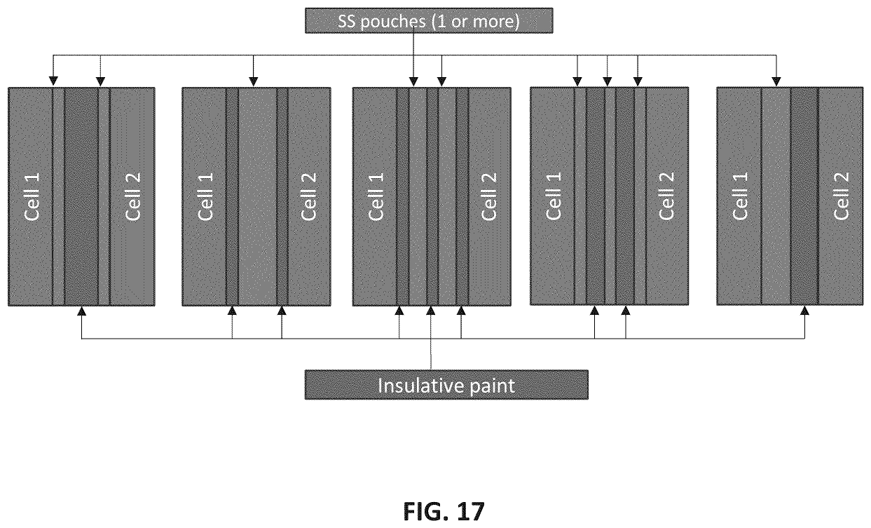

FIG. 17 illustrates examples of how the insulative paint layers and SS pouches may be arranged, in accordance with various example implementations of this disclosure. However, the paint and SS pouch layers may be arranged in any other possible combination not described here.

Three barrier designs, each with similar thicknesses (400-420 microns), are described in Table 3 below. Design A comprises a barrier composed solely of the insulating paint (ThermaCels-Flame Seal) with a coating thickness of ˜400 microns. Design B comprises a combination of two SS pouches with a 200-micron coating of the insulating paint. Design C comprises a combination of four SS pouches.

TABLE 3
Summary of TP tests with 3 different thermal barrier designs

| | | | C1-C2 TP time |
|---|---|---|---|
| | Thermal barrier | Cell capacity | (s) |
| A | ThermaCels- | 2 Ah | 19 |
| | Flame Seal paint | | |
| | (~400 μm) | | |
| B | ThermaCels- | 2 Ah | No TP |
| | Flame Seal paint | | |
| | (~200 μm) + | | |
| | 2 SS pouches | | |
| | (~210 μm) | | |
| C | 4 SS pouches | 2 Ah | 57 |
| | (~420 μm) | | |

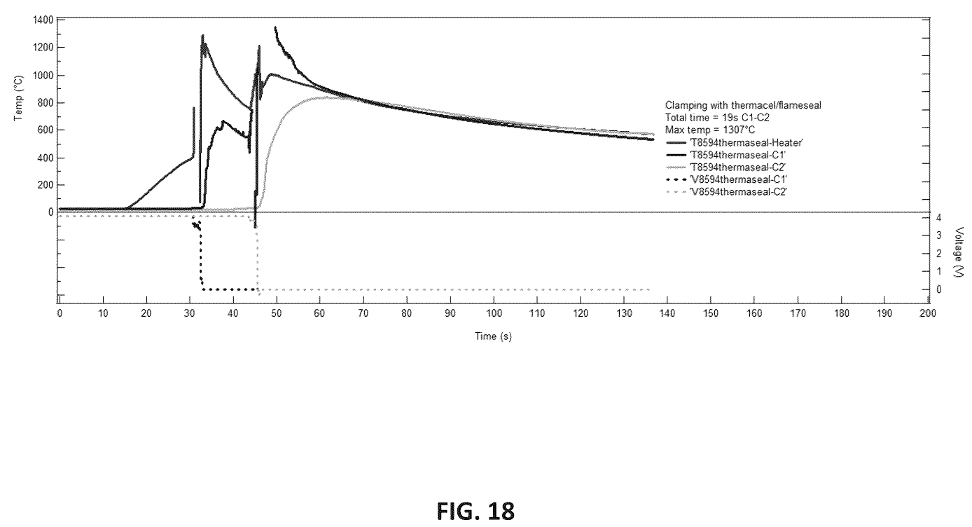

FIGS. 18-20 illustrate test results in which thermal propagation may be blocked by the SSW pouch under protection of the insulating paint, in accordance with various example implementations of this disclosure.

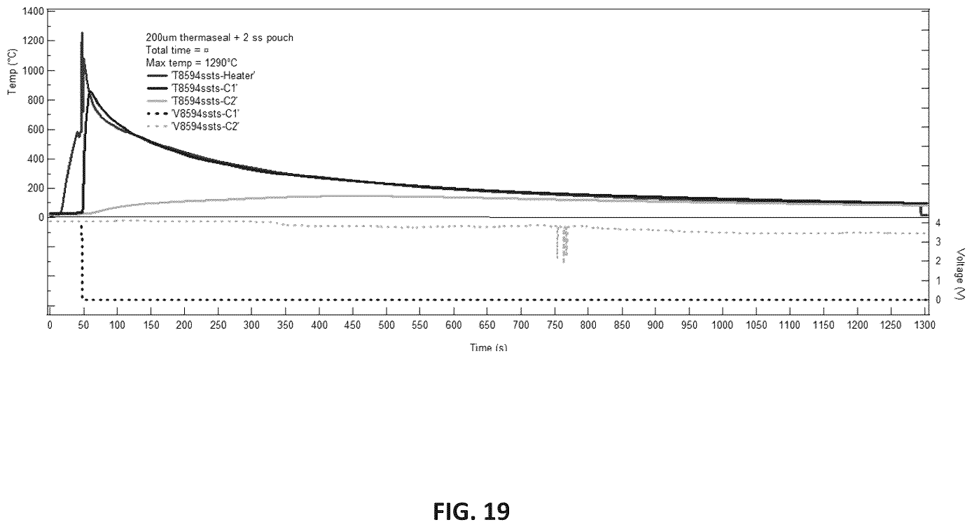

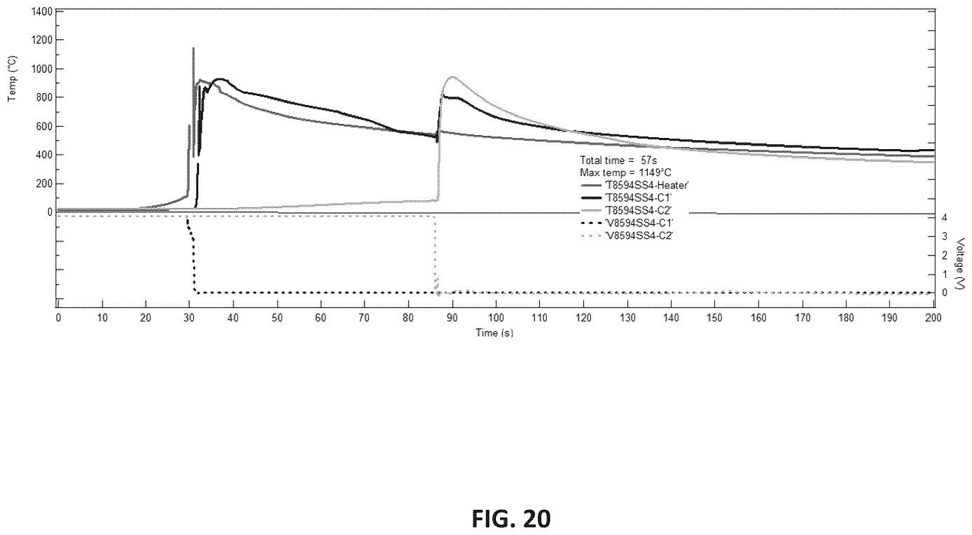

Among the three designs, Design B (results in FIG. 19) demonstrated the best TP performance, with no propagation observed in this clamped setup. Designs A (results in FIG. 18) and C (results in FIG. 20) showed cell-to-cell propagation times of 19 seconds and 57 seconds, respectively. The superior effectiveness of Design B (results in FIG. 19) may be due to the ability of the insulative paint to protect the SS pouches from melting when the trigger cell (cell-1) undergoes thermal runaway (TR), reaching temperatures in excess of 1500° C. (for NCM811-Si cells), which is well above the melting point of stainless steel. Therefore, for cells that reach very high temperatures (close to or greater than the melting point of stainless steel), such as NCM811-Si cell designs, a combination of the insulative paint and SS pouches may prove to be the most effective barrier design.

Aerogels are promising high-temperature insulation materials due to their low thermal conductivity. For battery TP applications, industry standards may utilize silica- or alumina-based aerogels. However, these materials are brittle, difficult to handle in thin-film form, and expensive. Additionally, they require a thickness of at least 1 mm to significantly mitigate TP, with typical applications needing 2-3 mm to fully prevent cell TP. This results in significant space consumption within battery packs, reducing overall energy density.

The novel foil pouch thermal barrier device differs significantly from traditional solutions. It exhibits extremely low thermal conductivity at high temperatures while remaining flexible, easy to handle, cost-effective, and thin. This barrier integrates multiple advantages of existing insulation materials without their drawbacks.

To mitigate TP risk, a multifaceted approach may be necessary, incorporating material design, chemical additives, and physical containment. These strategies broadly fall into several categories: heat absorption, reaction suppression, thermal isolation, and active flame retardancy.

The length and width of the pouch may exceed those of the cell stack to maximize heat insulation.

Various welding methods may be employed, including but not limited to ultrasonic welding, metal inert gas (MIG) welding, plasma welding, electron beam or laser welding, and gas welding. Sealants, such as polymer layers, may also be used, provided they can withstand high temperatures during thermal events.

Metal foil pouches may be fabricated using electric resistance welding (ERW). This process may involve applying low-voltage, high-current AC to the foil positioned between two electrodes (e.g., a copper plate and a copper disc). The welding joint, having higher resistance than the rest of the circuit, concentrates heat and brings the foil to its melting point. The molten surfaces then fuse under the pressure exerted by the copper disc against the copper plate.

Determining the maximum pressure the pouch can withstand is crucial for its application as a thermal barrier. To evaluate this parameter, the pouch may be placed between two steel plates with a fixed gap and then exposed to temperatures exceeding 100° C. in an oven. As the plate gap decreases, pressure on the pouch increases until it bursts. This process establishes the minimum volume applicable to the pouch. Given a known water volume, the water vapor volume can be calculated to determine the pouch's maximum pressure tolerance.

An insulating paint was also developed, incorporating a vacuum-based insulating additive and an intumescent material. The vacuum-based insulating additive may comprise, for example, ThermaCels (a ceramic vacuum sphere powder). The intumescent material may comprise, for example, a nonflammable insulating base paint, such as Flame Seal (an amine phosphate polymer intumescent coating). Any vacuum-based insulating additive and intumescent material may serve as alternatives.

The metal foil pouch and insulating paint may be integrated into the interior or exterior of the cell. For hard-case cells (cylindrical and prismatic), the metal foil pouch may be inserted and attached to the can before the stack or jelly roll is placed inside. Alternatively, the foil pouch may be applied to the surface or around the stack or jelly roll prior to insertion into the can.

The disclosed thermal barrier may offer flexibility and ease of handling. While aerogels are widely considered effective thermal insulation materials, silica- and alumina-based aerogels used in battery TP applications are brittle and difficult to handle in thin-film form. Additionally, the novel thermal barrier can withstand the high pressures typically encountered in battery packs, whereas aerogels may fail due to their highly porous structure.

A pressure range of 50 kPa to 400 kPa may be applied during TP testing, yielding consistent results. Pressure may be introduced using a constant-gap setup with foam pads positioned atop the cell stack.

The insulating paint may consist of ThermaCels-Flame Seal mixture or other comparable insulating coatings.

Utilizing metals with higher melting points preserves pouch integrity during thermal runaway events. Among stainless steel alloys, 309 stainless steel is particularly suited to this application due to its melting point of approximately 1400° C. Other applicable alloys include 309S and 310 stainless steel.

Polymers should not serve as the sole sealing mechanism for stainless steel pouches, as their integrity weakens or fails at elevated temperatures (80-200° C.). Continuous welding techniques or soldering can enhance the seal's resistance to high temperatures and pressures. Welds in this setup may withstand pressures up to 2970 kPa, with wider welds or alternative techniques enabling even higher tolerances. Resistance to pressures exceeding 200 kPa is desirable, with thresholds of >500, >1000, >1500, and >2000 kPa offering further advantages in preventing the pouch from bursting.

Insulating paint or other insulation methods may be applied to the stainless steel pouch to enhance robustness. This additional protection may enable the use of polymeric seals or lower-melting-point metals.

During thermal runaway, the advanced barriers described may provide protection by mitigating heat transfer between cells. However, expelled hot gases, flames, and hot solids or liquids may still pose risks. To counteract this, cells should be insulated against direct exposure to emitted materials. For stacked cells with barriers in between, the edges may remain vulnerable. Protective measures such as applying an insulating paint layer to exposed cell edges can help mitigate this risk. The ThermaCels-Flame Seal paint may be effective in this role.

Water is an advantageous gassing agent (phase change agent) due to its nontoxicity, availability, and rapid response. The amount of water should be proportionate to the pouch size and pressure tolerance. An optimal volume of water may be approximately 0.2-0.6 μL/cm², though variations in seal strength and materials may necessitate adjustments. Ideally, a metal that does not react with water should be used for the pouch, or an alternative gassing agent should be employed.

While references are made to stainless steel pouches (SS pouches), other metals may also be suitable. Similarly, the ThermaCels-Flame Seal paint or insulating paint may be substituted with any coating incorporating vacuum-sphere-based additives and an intumescent component.

Thermal propagation prevention strategies may be incorporated into individual cells, battery packs (e.g., electric vehicle packs), or other system components.

To ensure the effectiveness of SS pouches, hermetic sealing is essential to prevent water loss throughout the product's operational lifecycle. Quality testing and multiple redundant sealing strategies may be implemented to mitigate risks of water loss due to manufacturing defects or handling damage.

It should be noted that for the SS pouches to function effectively, it is critical to ensure that they are hermetically sealed so that there is no loss of water during the entire operational life cycle of the product. Therefore, it may be necessary to develop quality testing method. Optimizing the welding conditions is crucial to ensure hermetic sealing. It may be necessary to use multiple redundant sealing strategies in addition to the welds to reduce the likelihood of water loss in case the welds are compromised due to, for example, manufacturing defects/damage during handling/operation, etc. One or more of the following sealing strategies may be employed to ensure the pouches remain leak-proof and robust under a range of operating conditions.

This disclosure focuses on an airbag assembly with sensor integration and emergency response triggers for mitigating thermal propagation of lithium-ion battery, substantially as illustrated by and/or described in connection with at least one of the figures, as set forth more completely in the claims. The airbag may comprise a stainless steel welded (SSW) pouch. However, the materials (e.g., forming a pouch comprising a metallized polymer, stainless steel, or any other metal) and the sealing methods (e.g., welding, heat sealing, adhesive bonding, and others) may vary.

### Leaking Test for Water Pouch

As it may be difficult to identify pouches that may not be hermetically sealed due to defective welds (or other sealing methods), an accelerated leaking test is needed to check the welding/sealing quality. Dry room or other extremely dry atmosphere is a good accelerator that provides a high amount of driving force for water loss from defective pouches. Thus, the SS water pouches may be left in such an environment for a defined period of time while tracking their weight at certain intervals to identify defective (leaky) pouches based on the weight loss over time.

### Optimize the Welding/Sealing Parameters

The welding/sealing parameters' optimization includes but not limited to: welding/sealing pressure needs to be enough to make sure there is good contact; welder/sealer rolling speed cannot be too fast; welding/sealing energy (power and weld cycle to rest cycle ratio) cannot be too low (under weld) or too high (over weld or generate sparks); weld/seal cycle to rest cycle ratio needs to be high enough (e.g., >50% or >75%) to make sure rest cycle is not enough to generate bad welding/sealing points. The thickness (cross section under microscope) of the welded/sealed part will be 40%-80% of the original thickness.

### Multiple Parallel Welds

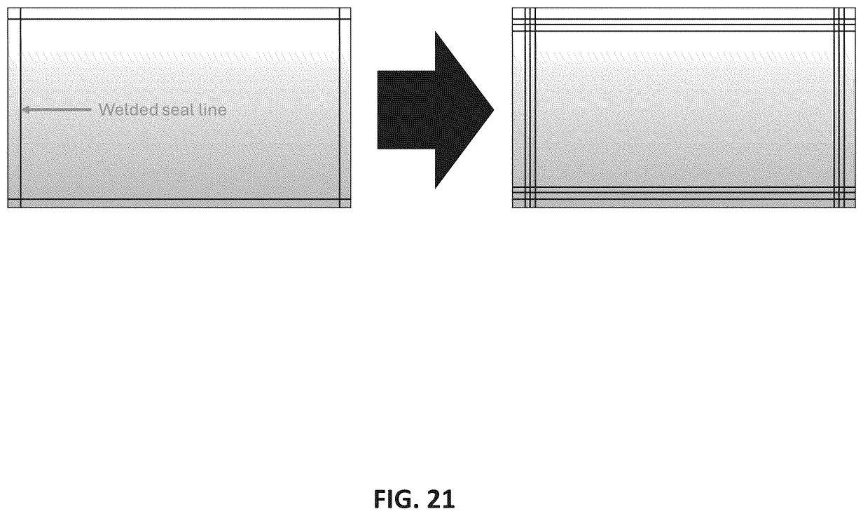

As shown in FIG. 21, multiple weld lines may be added in parallel as shown below to add redundancy and reduce the likelihood of water loss from defective weld points in any of the individual weld lines.

### Sealant Coatings

A wide range of sealants may be used to coat the SS pouches to seal off any leaky weld points. Examples that may be used include Boiled linseed oil, polyurethane, wax, epoxy-based sealant coatings, etc. The sealants may be applied to the SS pouch through a range of coating methods including but not limited to spray coating, dip coating, brush application, etc.

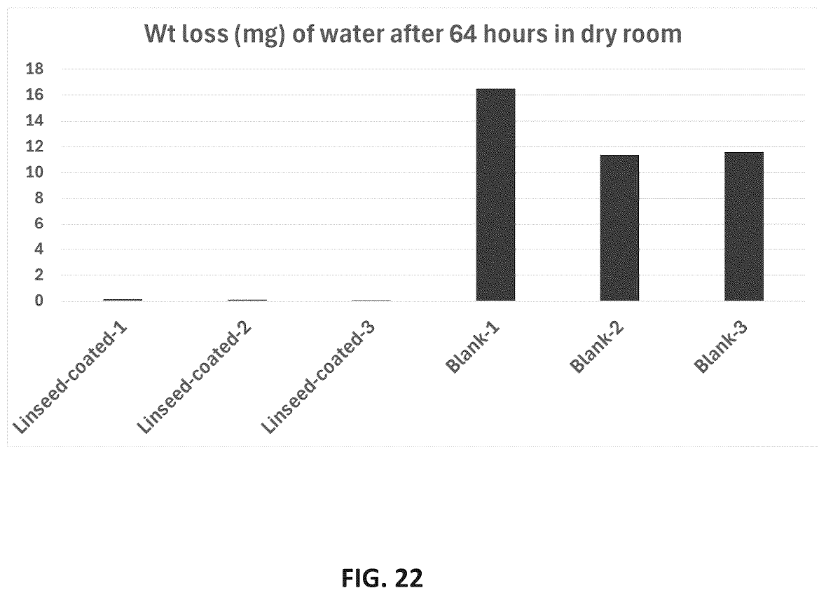

The chart in FIG. 22 shows the loss of water from a set of SS pouches with defective welds (resulting in significant water loss over time) stored in a dry room environment for 64 hours with and without boiled linseed oil coating. The linseed oil coating was able to significantly reduce the loss of water by sealing off the defective weld points.

To apply the linseed oil coating, the defective SS pouches were immersed in a bath of boiled linseed oil for 10 minutes and the excess oil was wiped down and allowed to dry for 24 hours.

Replacing and/or supplementing water inside the pouch with non-volatile agents that release gas/expand when activated:

The ideal candidate may be a non-volatile solid that releases a large volume of gas as it undergoes decomposition rapidly at temperatures ranging from 90-200 deg C. With this approach, the hermeticity of the seals become less critical. Examples of compounds that could be used here include NaHCO3, KHCO3, Azides like NaN3, Potassium hypochlorite, sodium borohydride, citric acid, Azodicarbonamide, p-Toluenesulfonyl hydrazide (TSH), expandable graphite, commercial intumescent products such as Flame Seal, 3M FireBarrier, FlameBuster, SpecSeal LCI Firestop Sealant, etc. When added with water, the materials can ensure that inflation of the pouch occurs even if there is leakage of the water. When water is replaced, the materials may be more robust as there is, ideally, no risk of leakage.

Dissolving salts/sugars/any solute that reduces the vapor pressure of the solution to slow down the rate of water loss in case the pouch has a leak.

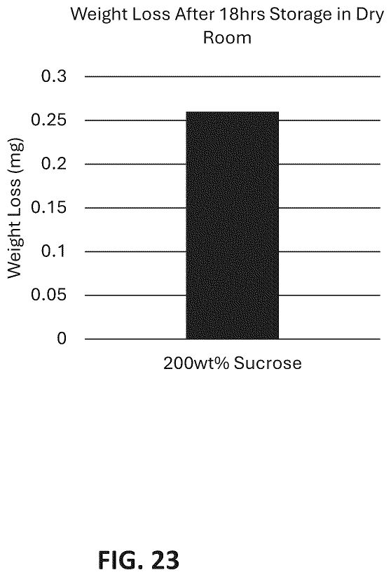

Sucrose may be mixed with water (e.g., in 2:1 sucrose: water ratio by weight). 118 ul of the solution was injected into the pouch (˜39.33 ul of water) before sealing. The pouch was stored in a low humidity dry room for 18 hours. The resulting weight loss is shown is FIG. 23.

In addition to the stainless steel water pouch and ThermaCels paint, one or more of the following strategies may be used or combined to further reduce the likelihood of thermal propagation.

One of the primary approaches to halting thermal propagation is through the incorporation of flame-retardant materials directly into the cell components via electrolyte, or they may be added using a heat triggered capsule or pouch inside the cell. Materials that may otherwise poison the cell may be released at ˜150 deg C., before the cell goes into full-scale thermal runaway. Some examples of extinguishing media are water, sodium or potassium bicarbonate, water-absorbing polymers, HFC-227ea, C6F12O, NH4H2PO4, sodium bicarbonate+aluminum sulfate, and phosphorus-based compounds such as APP (ammonium polyphosphate), AMP (ammonium monophosphate), phosphate esters, and phosphazenes, which act by promoting char formation and interrupting the combustion process.

Liquid-phase retardants like dimethyl methyl phosphonate (DMMP), triethyl phosphate (TEP), and tris(trifluoroethyl) phosphate (TFP) can be added to electrolytes to suppress ignition. Advanced organophosphorus compounds, including triethoxyphosphazen-N-phosphoryldiethylester (PNP), bis(2,2,2-trifluoroethyl)ethylphosphonate (TFEP), triethyl phosphite (TEPi), and (ethoxy) pentafluorocyclotriphosphazene (PFPN), offer high thermal stability and chemical reactivity with free radicals, further inhibiting combustion.

Some electrolyte salts like Li[B(DPC)(oxalato)], Li[B(DPC)₂], Li[B(DPC)F₂], and Li[P(DPC)₃] (that are derived from H2-DPC, i.e., tetraethyl (2,3-dihydroxy-1,4-phenylene)bis(phosphonate)) may be used for their dual functionality in stabilizing the electrolyte while acting as flame-retardants. These may be used as additives or replacements for other lithium salts for safer lithium-ion batteries.

Another class of effective flame suppressants includes halogenated compounds, which act by disrupting the radical chain reactions in combustion. These include tetrabromobisphenol A (TBBPA), pentabromodiphenyl ether (PentaBDE, DE-71), and tris(2-chloroethyl) phosphate (TCEP). Other advanced halogenated agents include hexabromocyclododecane, hexabromobenzene (HBB), decabromophenylether, chlorendic acid, 2,4,6-tribromophenol, allyl 2,4,6-tribromophenyl ether (ATE), tetrabromophthalic anhydride, pentabromotoluene (PBT), and bis(2-ethyl-1-hexyl) tetrabromophthalate (TBPH).

With these above flame retardants, some of the solvent or salts showing no harmful effects to the cell quality/performance could be put into the cells as a part of electrolyte. However, some other flame retardants are not compatible with cell chemistry and therefore may be added into a stainless-steel pouch which may then be inserted into the cells. To avoid the high clamping pressure during formation (if applicable), the stainless-steel pouch with flame retardant can be put into the cell during degassing.

Another approach to delay or suppress thermal propagation is by increasing the thermal mass of a cell to help absorb heat and slow temperature rise. Strategies include using heavier current collectors, incorporating inert fillers, such as alumina, graphite, LiOH, and LiF, KHCO3 or increasing anode loading.

Materials such as ceramic insulating paper, aerogel, rubber, silicones, fluoropolymers, ceramics, intumescent materials, extra foil layers, or oxidized foil layers may be used for internal or external applications to act as thermal barriers, reducing heat transfer between cells. Some materials may be self-standing and used internally or externally or coated on electrodes, separators, or applied to the exterior of the cell.

In the event of excessive heat buildup, forced shutdown mechanisms may inhibit thermal propagation. These include materials that foam or gas, physically breaking contact between electrodes or smothering the reaction site. Radical initiators or heat can also be used to polymerize the electrolyte, or electrolyte additives that may solidify at temperatures above the operating temperature window and below the TR temperature, such as mung bean protein isolate or PEG-400, can be used to cut off ion transport and stop further reaction.

There may be some highly exothermic reaction between the active materials and other cell components during cell heating that may be prevented. Surface-level treatments of active material particles, current collectors, or electrodes with carbon coatings allow for controlled thermal responses.

To deactivate the lithiated anode, encapsulated ethylene diamine and encapsulated water or alcohol may be added to the cell. These would be released in response to thermal events to neutralize lithium and reduce reactivity at the anode. A charring material, such as fructose, glucose, sucrose or other sugars or other compounds that melt and start charring at temperatures below or near TR trigger temperature may also be used to block the anode from additional reactivity once the cell begins to exceed the operating temperature.

More aggressive mitigation approaches may be used, including the use of guanidine nitrate, potassium-based compounds, and ammonium salts or perchlorates such as ammonium sulfate (SULF-N). These would actively disrupt thermal runaway by quickly destroying cell function in a controlled way

Strategies to quickly reduce the cell SOC may also be used to improve the likelihood of thermal propagation prevention. These include adding extra foil overhang with resistive coating that melts once the cell begins to exceed the operating temperature embedding conductive particles next to the separator, and using materials that remain stable at normal operation but activate at a critical temperature to either re-stabilize the cathode by insertion into the cathode structure, thus suppressing oxygen release, or to react with the lithium stored in the anode, thus reducing the cell SOC and energy.

The paint layers and/or the stainless steel pouch described in this disclosure may incorporate extinguishing media designed to suppress or extinguish flammable gases or thermal events within the cell. The extinguishing media may be volatile, allowing it to vaporize and become gaseous when exposed to elevated temperatures. Some examples of extinguishing media are water, sodium or potassium bicarbonate, water-absorbing polymers, HFC-227ea, C6F12O, NH4H2PO4, sodium bicarbonate+aluminum sulfate, and phosphorus-based compounds such as APP (ammonium polyphosphate), AMP (ammonium monophosphate), phosphate esters, and phosphazenes, which act by promoting char formation and interrupting the combustion process.

Additionally, the paint may include nanomaterials (e.g., graphene, doped graphene, or other suitable materials) that offer insulating, fire-retardant, or fire-extinguishing properties. These nanomaterials may enhance thermal management and safety of the cell by inhibiting ignition or assisting in flame suppression during thermal runaway events.

The disclosed system provides a sensor-integrated battery protection system comprising sealed and/or folded structural members positioned between battery cells. These structures incorporate embedded sensors capable of detecting pressure buildup, temperature rise, strain, cell deformation, and gas evolution. Upon detection, the system initiates defined mitigation protocols such as alerts, shutdowns, or cooling activation. The architecture supports deployment from individual cells to full vehicle packs and enables data logging, diagnostics, and system redundancy.

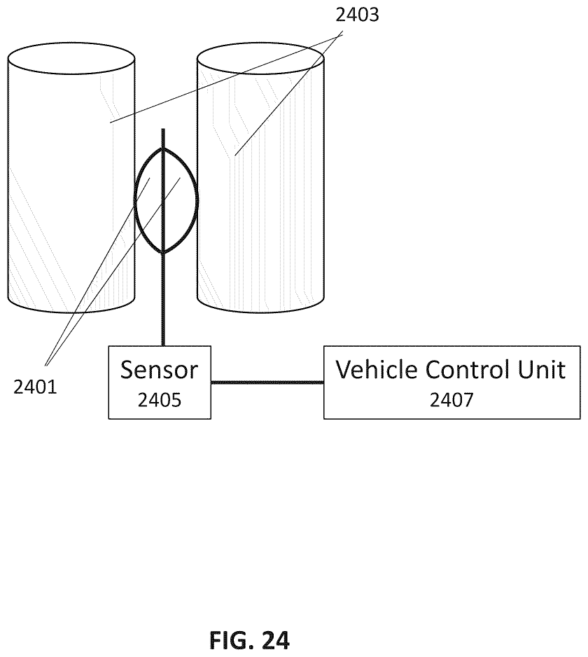

FIG. 24 illustrates a chamber assembly 2401 with sensor 2405 integration and emergency response triggers in accordance with various example implementations of this disclosure.

The system comprises electrochemical cells 2403 separated by sealed or folded structural members, e.g., made of welded metal or composite materials. These elements comprise internal chambers 2401 that deform or expand during thermal runaway events.

Embedded sensors 2405 may be positioned at weld seams, fold axes, or inflation chambers, depending on the event profile being monitored. Pressure sensors may be used to detect inflation from vaporization or chemical reactions. Temperature sensors or thermocouples may be used to capture local heating from failing cells. Strain or force transducers may be used to detect cell swelling or pouch expansion due to internal gas generation. Gas sensors may be used to detect specific volatile compounds or pressure rise within the battery pack. Displacement sensors may be used to monitor cell movement caused by expansion forces.

These sensors 2405 may be configured to detect either early-stage thermal indicators or late-stage venting, depending on placement and required response time.

The system is connected to a digital communication interface such as CAN bus, allowing real-time transmission of sensor data to the vehicle's battery control unit 2407. Detection of a critical event may trigger an alerts to the vehicle operator, a controlled electrical shutdown, an initiation of cooling or venting systems, and/or logging of event data for later diagnostic or warranty analysis.

Sensor update rates may vary, ranging from high-frequency polling (e.g., every 10 ms) to event-driven triggers, depending on system architecture. Redundant sensing, e.g., different sensor types, may ensure reliability and minimize false positives.

Sensors may comprise self-diagnostic routines or calibration checks to ensure functionality.

The sensor-integrated structure may comprise phase-change materials or reactive inserts for additional mechanical or thermal response. The entire sensorized structure may be formed as a trimmable strip or panel, allowing flexible installation across cell, module, or pack levels.

Legacy battery packs may be retrofitted with this system by inserting sensorized dividers or replacing structural elements. The approach supports modular upgrades and incremental safety enhancement.

This battery protection airbag provides a novel, passive, and scalable mechanism for interrupting thermal propagation while also offering durability, manufacturability, and multi-trigger responsiveness. It is optimized for rapid phase-change expansion, thermal isolation, and structural modularity, making it suitable for a wide range of energy storage applications.

As used herein, “and/or” means any one or more of the items in the list joined by “and/or”. As used herein, the term “exemplary” means serving as a non-limiting example, instance, or illustration. As used herein, the terms “e.g.,” and “for example” set off lists of one or more non-limiting examples, instances, or illustrations. As used herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.). As used herein, the term “based on” means “based at least in part on.” For example, “x based on y” means that “x” is based at least in part on “y” (and may also be based on z, for example).

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

1. A battery system, comprising:
at least one sealed chamber disposed between a plurality of battery cells; and
at least one sensor configured to detect a physical condition of the sealed chamber and trigger a response, wherein:
the sealed chamber is configured to mechanically deform when subjected to mechanical force resulting from swelling of an adjacent battery cell, and
the sensor is configured to detect mechanical strain or expansion of the sealed chamber associated with swelling of the adjacent battery cell.

2. The system of claim 1, wherein the sensor is a pressure sensor detecting inflation of the at least one sealed chamber.

3. The system of claim 1, wherein the sensor is a thermocouple affixed to a conductive metal surface.

4. The system of claim 1, wherein the response comprises notifying a vehicle operator and initiating a controlled shutdown.

5. The system of claim 1, wherein the at least one sealed chamber is filled with a pressure-reactive material and the sensor detects mechanical strain at a welded seam of the sealed chamber.

6. The system of claim 1, wherein the sensor is configured to detect an early-stage battery venting and signal a preemptive cooling prior to a thermal runaway condition.

7. The system of claim 1, wherein the system comprises logging of a thermal event.

8. The system of claim 1, wherein the at least one sealed chamber is formed from welded metal sheets and the sensor is embedded at the weld seams.

9. The system of claim 1, wherein the at least one sealed chamber and the sensor are positioned between adjacent battery cells within a battery module.

10. The system of claim 1, wherein the sensor comprises self-diagnostic capabilities.

11-20. (canceled)
